(19) United States
(12) Patent Application Publication
(10) Pub. No.: US 2021/0390153 A1
(43) Pub. Date: Dec. 16, 2021

(54) Formulated Query On Portable Device

(71) Applicant: Google LLC, Mountain View, CA (US)

(72) Inventor: Peter Lewis, Zurich (CH)

(73) Assignee: Google LLC, Mountain View, CA (US)

(21) Appl. No.: 16/980,971

(22) PCT Filed: Jun. 16, 2020
(86) PCT No.: PCT/US2020/037868

§ 371 Date: Sep. 15, 2020

(51) Int. Cl. G06F 16/9537; G06F 3/0486; H04L 29/08; G06F 16/29; G06F 16/9538; G01S 19/42

(52) U.S. Cl. CPC G06F 16/9537; G06F 3/0486; H04L 67/18; G06F 3/0482; G06F 16/9538; G01S 19/42; G06F 16/29

(57) ABSTRACT

Methods and apparatus that may perform a drag-and-drop operation for a geographical query in a digital map are provided with reduced or minimum textual input. In one example, the method includes providing, by one or more processors, a digital map for display on a computing device, providing, by the one or more processors, a preformulated query for display in a user interface, receiving an input applied to the preformulated query, wherein the input indicates an application of the preformulated query to a selected region of the digital map, and performing, by the one or more processors, a geographic search based on the input applied to the preformulated query.

### BACKGROUND

Use of portable devices, such as smart phones or tablets, has been significantly increasing. Such devices may be of a limited size that make interaction via a keyboard less practical than for a desktop or laptop computer. Limited size of the portable devices often decreases the efficiency with which information can be inputted by reducing the number and size of the keys. Consequently, a textual input with lengthy or multiple queries in portable devices is often time consuming and may be difficult for a search engine to correctly understand. In effect, it is more difficult to provide an effective human-computer interaction. The generally smaller nature of smart phones or tablets creates physiological challenges for interaction by a human user. For example, when the textual input includes multiple queries, such as a particular thing or activity available at or around a particular location, the textual input may not be formulated in a manner that the search engine may easily understand, thus resulting in inaccurate search results.

### BRIEF SUMMARY

One aspect of the disclosure provides a drag and drop operation for a geographical query in a digital map in a computing device. In one aspect, a method of performing a query includes providing, by one or more processors, a digital map for display on a computing device, providing, by the one or more processors, a preformulated query for display in a user interface, receiving an input applied to the preformulated query, wherein the input indicates an application of the preformulated query to a selected region of the digital map, and performing, by the one or more processors, a geographic search based on the input applied to the preformulated query. An improved human-computer interaction is therefore provided. In addition, less processing is required to perform a multi-dimensional search task.

According to some examples, the method further includes projecting, by the one or more processors, a plurality of search results in close proximity to the selected region in the digital map. The method further includes filtering the search results based on a filtering command as received. In some examples, the providing of the preformulated query further includes detecting, by one or more processors, a geographic location of a user, and marking, by one or more processors, the geographic location of the user in the digital map.

In some examples, the input applied to the preformulated query at the selected region of the digital map is in close proximity to the geographic location at where the computing device is located. In some examples, the preformulated query is represented as a textual bubble in the digital map. In some examples, the textual bubble is editable. The preformulated query comprises a textual label related to attributes or local resources in close proximity to the geographic location. The preformulated query is presented at a preset location in the user interface irrelevant to a geographic location presented in the digital map. The input is a drag and drop command. The geographic search is completed by the drag and drop command applied in the digital map with minimum textual input.

Another aspect of the disclosure provides a computing device. The computing device includes one or more memories, one or more processors in communication with the one or more memories, the one or more processors configured to provide a digital map for display on a computing device, provide a preformulated query for display in a user interface, receive an input applied to the preformulated query, wherein the input indicates an application of the preformulated query to a selected region of the digital map, and perform a geographic search based on the input applied to the preformulated query at the selected region.

In some examples, the computing device is a GPS enabled portable device. The computing device is a database server in communication with one or more user devices. The input is a drag and drop command. The preformulated query is represented as a textual bubble in the digital map.

Another aspect of the disclosure provides a computer-readable storage medium. The computer-readable storage medium includes executable computer instructions for performing operations includes providing a preformulated query for display in a user interface, receiving an input applied to the preformulated query, wherein the input indicates an application of the preformulated query to a selected region of the digital map, and performing a geographic search based on the input applied to the preformulated query at the selected region.

In some examples, the input is a drag and drop command. The preformulated query is represented as a textual bubble in the digital map. In some examples, the computer-readable storage medium comprising executable computer instructions further includes detecting a geographic location of a user and marking the geographic location in the digital map prior to receiving the input applied to the preformulated query.

### BRIEF DESCRIPTION OF THE DRAWINGS

FIG. 1 is a block diagram of an example computing device according to aspects of the disclosure.

FIG. 2 is a digital map generated from a map application in the example computing device depicted in FIG. 1 according to aspects of the disclosure.

FIG. 3 is a zoomed-in map of the digital map of FIG. 2 according to aspects of the disclosure.

FIG. 4A-4B are digital maps that may perform a drag and drop operation according to aspects of the disclosure.

FIG. 5 is a digital map that provides different suggested queries according to aspects of the disclosure.

FIG. 6 is a list with additional suggested activities according to aspects of the disclosure.

FIG. 7A-7B are a map and a list with additional suggested categories according to aspects of the disclosure.

FIG. 8A-8C are digital maps with different target locations zoomed in the maps according to aspects of the disclosure.

FIG. 9 is a flow-diagram illustrating an example method of performing a drag and drop operation in a digital map applied in a portable device according to aspects of the disclosure.

### DETAILED DESCRIPTION

The present disclosure provides for performing a drag and drop operation for a geographical query in a digital map in a computing device. The drag and drop operation allows the user to input a formulated query in a digital map with reduced or minimum textual input so as to provide a relatively accurate query that the computing device may capture and understand easily. For example, multiple formulated queries, such as suggested searches including textual tabs or textual bubbles, may be preset or pre-formulated in a map application. Accordingly, when the map application is launched and executed in the computing device, the formulated queries will appear on a display screen of the computing device along with a base digital map. Therefore, a user can simply drag the formulated query that meets his or her search intent, which is already preset and appeared on the display, to a target geographic region on the digital map. Thus, the intended query may be simply dragged and dropped to the target geographic region in the digital map defined with minimum textual input. As a result, the computing device may easily identify and understand the query command input from the user and respond the user with a geographical information that fits the user's intent of the query with minimum misunderstanding and/or input information/time from the user, thus saving input time, reducing likelihood of input error and enhancing search accuracy and efficiency. The result is an improved human-computer interaction that enables easier use of the device by a user taking into account the physiological constraints the user faces when using the device.

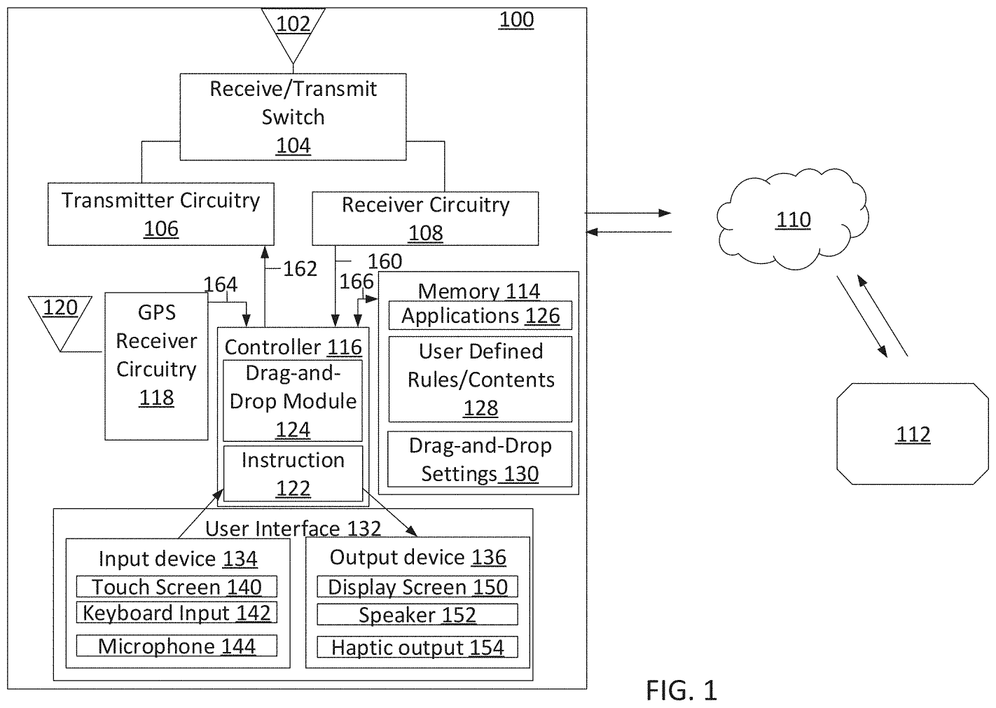

FIG. 1 depicts a detailed block diagram of an example computing device 100. The computing device 100 may be any device that can perform a computational operation. Suitable examples of the computing device 100 include desktop computers, laptop computers, PDA, personal computer, tablets, portable devices, such as smart phones, mobile phones, wearable devices and the like. In one example, the computing device 100 utilized herein is a smart phone. However, the computing device 100 described herein is not limited in this regard.

In one example, the computing device 100 has multiple components embedded therein. Each component may be in direct or indirect communication to each other. In the example depicted in FIG. 1, the computing device 100 includes one or more controllers 116 configured to be in electrical communication with a user interface 132, a memory 114, a GPS receiver circuitry 118, a transmitter circuitry 106 and a receiver circuitry 108. The one or more controller 116 can be any suitable processors, such as a microprocessor. Alternatively, the controller 116 can be dedicated components such as an application specific integrated circuit (“ASIC”) or other hardware-based processor. Although not necessary, one or more of computing devices 100 may include specialized hardware components to perform specific computing processes, such as geographic coordination reading, street image recognition, GPS related searches and positioning, geographic location encoding, etc.

An antenna 102 may be disposed in the computing device 100 configured to receive and transmit Radio Frequency (RF) signals, WiFi signals, bluetooth signals, GPS signals or any suitable electrical signals. A receive/transmit (Rx/Tx) switch 104 selectively couples the antenna 102 to the transmitter circuitry 106 and receiver circuitry 108 as needed. The receiver circuitry 108 demodulates and decodes the electrical signals received from a network 110 to derive information therefrom. The network 110 may be further communicated with a database server 112 so as to provide information requested or inquired by the computing device 100. The network 110 provides connectivity between the computing device 100 and the database server 112. The network 110 may utilize standard communications protocols, such as internet, Ethernet, WiFi, satellite communications, HTTP and protocols that are proprietary to one or more companies, and various combinations of the foregoing. For example, the network 110 may be wired or wireless local area network (LAN), wide area network (WAN), cellular communication network as needed. The database server 112 may also be a computing device which also includes at least one processor, a receiver/transmitter, an interconnection interface and a memory that may store, send and/or generate information, data, software applications, map data, content, or interactive applications to the computing device 100. Thus, during operation, the database server 112 may execute operations including receiving requests from the computing device 100, such as a device that a user is interacting with, through the network 110. Subsequently, the database server 112 may then process, respond and provide the requested content, interaction, map data, or information through the network 110 to the computing device 100.

In one example, the receiver circuitry 108 is coupled to the controller 110 via an electrical connection 160. The receiver circuitry 108 provides the decoded electrical signals information to the controller 116. The controller 116 also provides information to the transmitter circuitry 106 for encoding and modulating information into electrical signals. Accordingly, the controller 116 is coupled to the transmitter circuitry 106 via an electrical connection 162. The transmitter circuitry 106 communicates the electrical signals to the antenna 102 for transmission to the database server 112 through the network 100.

In one example when the computing device 100 includes a GPS-enabled implementation, an antenna 120 is coupled to GPS receiver circuitry 118 for receiving GPS signals. The GPS receiver circuitry 118 demodulates and decodes the GPS signals to extract GPS location information therefrom. The GPS location information indicates the location of the computing device 100. The GPS receiver circuitry 118 provides the decoded GPS location information to the controller 116. As such, the GPS receiver circuitry 118 is coupled to the controller 116 via an electrical connection 164. It is noted that the present disclosure is not limited to GPS based methods for determining a location of the computing device 100. Other methods for determining a location of the computing device can be used herein as needed. It is noted that when a GPS receiver circuitry is not utilized or present in the computing device 100, the receive/transmit (Rx/Tx) switch 104 along with the a transmitter circuitry 106 and the receiver circuitry 108 may also function similar to the GPS receiver circuitry to provide the geographic information/location of the computing device 100 as needed.

In one example, the controller 116 stores the decoded electrical signal information and the decoded GPS location information in the memory 114 of the computing device 100. Accordingly, the memory 114 is connected to and accessible by the controller 116 through an electrical connection 166. The memory 114 of the computing device 100 may store information accessible by the one or more of the controllers 116 or processors, such as including instructions 122 that can be executed by the one or more controller 116. In one example, the memory 114 is a computer-readable storage medium comprising the instructions 112, which are executable computer instructions, for performing operations or commands input to the computing device 100. The memory 114 can also include applications 126, user and/or client defined rules or contents 128 or drag-and-drop operation settings 130, which are settings of a drag-and-drop operation, and so on can be retrieved, manipulated, processed, executed, interacted or stored by the controller 116. In one example, the memory 114 may be a volatile memory and/or a non-volatile memory or any non-transitory type capable of storing information accessible by the controller/processor, such as a hard-drive, memory card, RAM, DVD, CD-ROM, a Dynamic Random Access Memory (DRAM), a Static Random Access Memory (SRAM), Read-Only Memory (ROM), flash memory, write-capable and read-only memories. The memory 114 can also have stored therein of software applications 126, for example, a map application, for implementing the methods of embodiments of the present disclosure including user-defined rules or contents 128 as well as the drag-and-drop settings 130 that may be utilized in the computing device 100.

Various implementations may be utilized to provide geographic location information to be written into memory 114. For example, a user may directly provide the location information by direct input to a user interface 132 on the computing device 100. Similarly, other methods of establishing the position of the computing device 100 may be employed, such as by triangulation of communication signals from known locations/towers, and the like. The computing device 100 may be or may not be GPS-enabled or even include communication features such as provided by antenna 102, 120 and receive/transmit switch 104, although the example computing device 100 depicted in FIG. 1 would include these features.

In one example, the applications 126 stored in the memory 114 may include, but are not limited to, software applications operative to perform the various methods, features and functions described herein. The user defined rules/contents 128 configured in the memory may also allow for custom map generation, image manipulation, preference settings by the users and the like when a map application is utilized.

Furthermore, the drag-and-drop settings 130 may also be configured or stored in the memory 114 that allow the user to repetitively use these settings for a user customized drag-and-drop operation. For example, a user may formulate his/her customized search queries to be saved in the memory 114. Accordingly, such search queries may be saved and configured as preset draggable commands that may be easily dragged to be dropped at a target geographic region in a digital map when such queries are selected. It is noted that the drag-and-drop settings 130 in the memory 114 may be in electrical communication with a drag-and-drop module 124 configured in the controller 116, or called a processor, so as to enable the operation of the drag-and-drop settings 130 being performed in the drag-and-drop module 124 by the controller 116 when needed.

As depicted in FIG. 1, one or more sets of instructions 122 may be saved, completely or at least partially, within the controller 116 during execution thereof by the computing device 100. Alternatively, one or more of the instructions may be stored in the applications 126 or other modules in the memory 114. In this regard, the memory 114 and the controller 116 can constitute machine-readable media. The term “machine-readable media”, as used here, refers to a single non-transient medium or multiple non-transient media that store the one or more sets of instructions 122. The term “machine-readable media”, as used here, also refers to any medium configured to store, encode or carry the set of instructions 122 for execution by the computing device 100 and that cause the computing device 100 to perform one or more of the methodologies of the present disclosure.

The drag-and-drop module 124 is configured in the controller 116 to provide a drag-and-drop operation on the computing device 100. In one example, the drag-and-drop module 124 may provide a drag-and-drop operation that may be activated when a user performs a drag command, such as a long press, a smudge, a two-finger tap, or some other finger gesture or combinations of the finger gestures. In one example, the drag-and-drop module 124 may provide the opportunity for the user to select or perform a preformulated query on the display screen in response to a drag command and until the drag command is dropped to a target region. The dropped command generates a dropped content, i.e., the formulated query, in the target region for a computational operation. The computational operation then converts the dropped content in a proper format to be performed or depicted at the target region. The dropped content received at the target region may populate entities, features, attributes, objects, or indicators at the target region in response to the query dragged and dropped by the user. Thus, the drag-and-drop module 124 provides the user a simple interactive interface that may perform a query by a drag-and-drop operation, rather than performing a textual or audio input by utilizing a keyboard interface or other relatively time consuming input mechanisms.

The drag-and-drop module 124 may also provide a predictable drag-and-drop operation that may represent information about past drag-and-drop experiences or saved drag-and-drop settings. Such past drag-and-drop experiences or saved drag-and-drop settings may be used by a machine learning algorithm to predict drop locations likely to be relevant based on the past drag-and-drop operations or past search experiences. In some implementations, the drag-and-drop operation may represent past actions of the user of the computing device 100. The suggested drop locations may be based on the entity type of the entity identified in the drop region. For example, the drag-and-drop operation may indicate that a query of a restaurant entity is often dropped into a particular location, such as a school, where the user often appears. Accordingly, a suggested drop location may be generated based on the past drag-and-drop experiences by utilizing the machine learning algorithm in the computing device 100. A user interface may allow the user to select or reject suggested drop locations. If there are no suggestions, or if the user fails to select a suggestion, the drag-and-drop operation may provide an indication that the drag-and-drop module 124 awaits a drop command as the user navigates on the computing device 100. The drop location may be any area on the display screen of the computing device 100. Thus, the drop location is determined by a drop command.

As illustrated in FIG. 1, components of the drag-and-drop module 124 may be executed on the computing device 100. In some implementations, one or more components of the drag-and-drop module 124 may be executed on the database server 112. For example, the computing device 100 may send queries selected by a drag operation to the database server 112 for recognition, calculation or analysis and the database server 112 may provide one or more entities identified in the selected or dropped location. In other words, the computing device 100 may send a query command to the database server 112 and the database server 112 may provide results responsive to the query command.

The controller 116 is also connected to a user interface 132. The user interface 132 includes input devices 134, output devices 136, and software routines or other user interface (not shown in FIG. 1) configured to allow a user to interact with and control applications 126 and the instruction 122 installed on the computing device 100. In one example, the applications 126 may, for example, provide for the use of other positioning technologies in addition to or instead of GPS, such as, but not limited to other satellite-based positioning systems or other techniques such as IP geolocation, or the like. Such input and output devices 134, 136 may respectively include, but are not limited to, a display screen 150, a speaker 152, a keypad 142, a microphone 144, a touch screen 140, a haptic output 154 and so on. It is noted that the display screen 150 and the touch screen 140 as described herein may refer to the same object to provide multiple functionalities. For example, the display screen 150 may not only display content but also provides a touch-activated interface, referred as a touch screen 140, that allows the user to input command and to actively interact therewith. The input and output devices 134, 136 may include less, more, or different devices including a directional pad, a directional knob, accelerator, a Push-To-Talk (“PTT”) button, sensors, a camera, a Radio Frequency Identification (“RFID”)/Near Field Communication (“NFC”) reader, sound/audio recognition devices, motion detector, accelerometers, activity monitors, and the like.

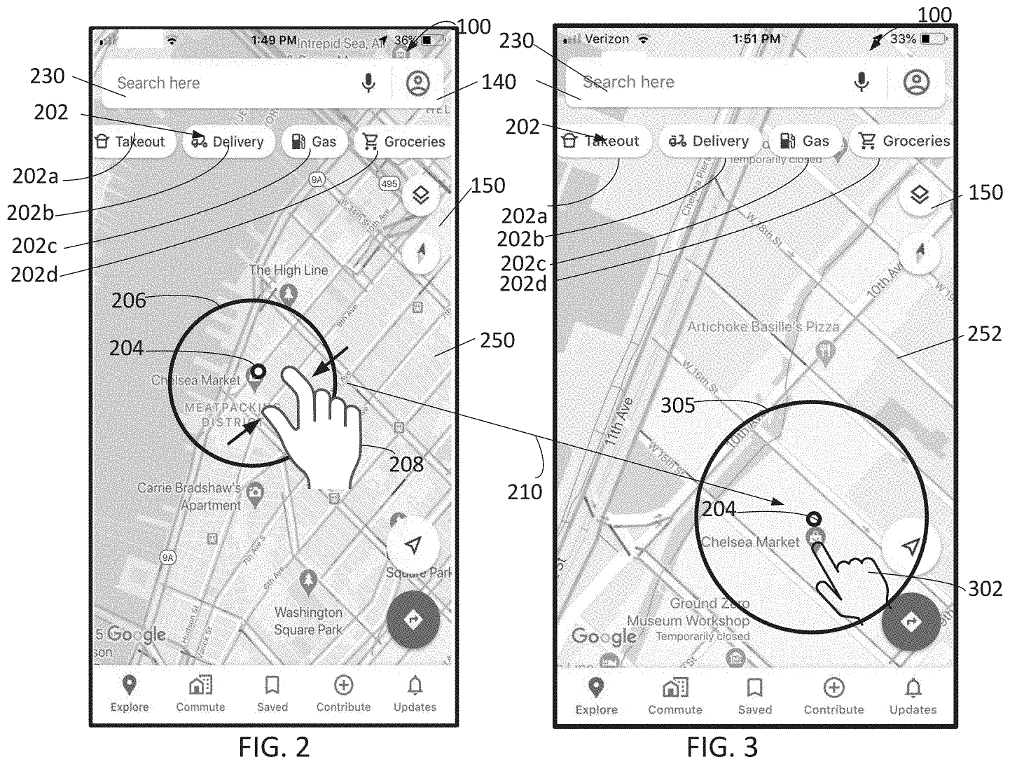

FIG. 2 is an example of a digital map generated from a map application in an example computing device, such as the computing device 100 depicted in FIG. 1, according to aspects of the disclosure. As shown in FIG. 2, when the map application is launched and in use in the computing device 100, a digital image of a digital map 250 is shown on the display screen 150 of the computing device 100. The map application executed in the computing device 100 may include several useful modalities, including location browsing, map searching, route identifying, target location search, geographic information acquisition, and route navigating operations. The map application is defined to be executed by the computing device 100 having the display screen 150 that displays the output, such as a digital map image, of the map application. In some embodiments, the computing device 100 may have multiple touch interfaces for allowing a user to provide touch and gestural inputs through the touch screen 140 to interact with the map application.

In one example, a current location of the user utilizing the computing device 100 may be automatically provided by a variety of ways. For example, the GPS receiver circuitry 118 embedded in the computing device 100 may provide and determine the exact location of the user. In another example, a cellular telephone connection can be used for determining and retrieving location information using triangulation or distance measuring techniques. Alternatively, a local network, such as WiFi, Bluetooth or other internet service may also be utilized to provide the location of the user, based on the signal emitted from the computing device 100 with which the user is interacting. The map application may retrieve the digital map information from an internet mapping source, for example, a map service provider or entity, through the internet connection. The digital map information may include location information and geographic coordinates, such as GPS coordinates, latitude and longitude and other attribute information, such as names, sizes, shape, roads, restaurants, parks, buildings, businesses, hospitals and the like of the various features in the local area. The map application operated on the computing device 100 may geo-locate the computing device 100 on the digital map and set the location as a marker so that the user can visually identify his/her geo-location in the map. The digital map may be shown in a two-dimensional or a three-dimensional representation.

In the example depicted in FIG. 2, the map 250 is a two-dimensional map that has a visual representation of a particular region 206 as viewed from an overhead viewpoint. In this example, a position of the computing device 100 is indicated and identified by a marker 204 located in the particular region 206. It is noted that the marker is a type of interactive visual indicator that indicates a specific feature in the map and may be overlaid on the map. For example, the position of a marker may represent the location of a particular restaurant or business. Alternatively, markers can be placed by a user that interacts with the map and so on. The map application from the computing device 100 provides an interactive interface so that the users can interactively control and adjust the marker through the touch screen input to the computing device 100 to access the map data/map information. Accordingly, a change or update of the geographic information related to the user's control, search, query and intent may be reflected or received instantly as the user controls and interacts with the map application.

In one example, in addition to the marker 204 depicted in the map 250 that indicates the position of the user, a plurality of textual bubbles 202 (shown as 202a, 202b, 202c, 202d) may also be populated on the digital map 250. It is noted that the textual bubbles 202 may be shown at a location/region of the digital map that would not generate visual interference to a user when the user interacts with the digital map. For example, the textual bubbles 202 is often programmed to be located at a location/region relatively away from the marker 204 shown in the digital map. Accordingly, when the user is investigating his/her geo-location in the digital map, the textual bubbles 202 may not be able to intervene or block his/her visual contact or sight to the marker 204. This therefore has the physiological advantage of not interfering with high traffic areas of the touch screen interface where the user is likely to both be looking and interacting with the map. In one example, the textual bubbles 202 are configured to be presented at a fixed location of the display screen irrelevant to an actual geographic location depicted in the digital map. For example, the location where the textual bubbles 202 is presented and populated in the display screen or the digital map does not move when a user zooms in or out, swipes, pinches, or otherwise manipulates the digital map for different geographic searches. For example, the textual bubbles 202 do not move as the marker 204 moves when a user performs a touch operation to the digital map, unless a drag-and-drop operation or other input associated with the textual bubbles is received, such as a long press to the textual bubbles 202 to trigger the textual bubbles to be draggable. The textual bubbles 202 are preset and/or pre-formulated queries provided by the map application stored and set in the memory 114 of the computing device 100. In another example, the textual bubbles 202 generally include textual labels that may be pre-edited, customized or personally formulated by the user to include map information, landmarks, activities, attributes, facilities or features, such as restaurants, cafés, food deliveries, gas stations, groceries, or other features, based on the interest of the individual users. The textual bubbles may alternatively be any suitable interface for selecting a map feature identifier.

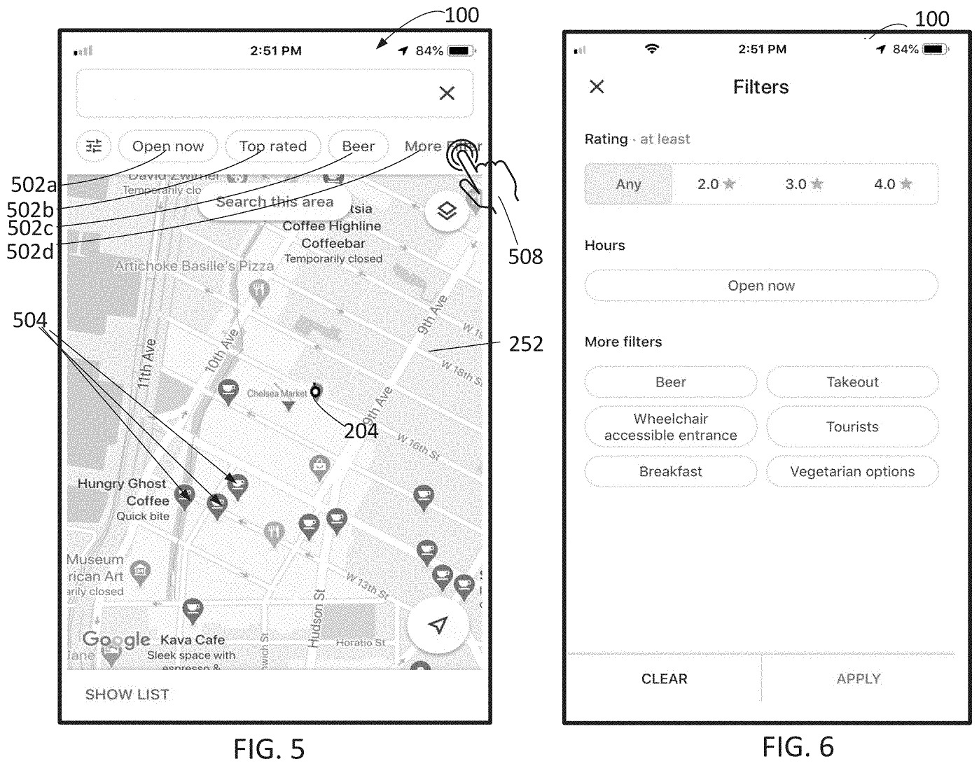

In the example depicted in FIG. 2, the textual bubbles 202 including a first set of the formulated text inquiries, such as takeout 202a, delivery 202b, gas 202c and groceries 202d may be populated in the digital map 250 as the map application launched in the display screen of the computing device 100. It is noted that several other formulated textual inquiries, such as a second set of the formulated textual inquiries, may also be preset to be shown on the display screen by a touch operation from the user. The user may slide and swipe away the first set of the formulated text inquiries 202a, 202b, 202c, 202d to show the second set of the formulated textual inquiries, such as pharmacies 202e, coffee 202f, hotels 202g and more 202h, as shown in FIGS. 4A-4B. The textual bubbles 202 preset and appeared on the digital map 250 may help the user to identify and categorize his/her search intent more instantly, when viewing the textual suggestions from the textual bubbles 202. Accordingly, a textual input or audio input (to be input to a search box 230) by user typing in keyboard or audial/sound input to the computing device 100 may be eliminated so that the likelihood of typographic error, sound recognition failure, and textual input command unclarities that often occurred using the textual input may be eliminated and reduced. Thus, a search/query experience more reflective to the user's intent is obtained, search input time is reduced, and user satisfaction is improved. Furthermore, less processing is required when a user makes a selection rather than inputting specific data, which then has to be interpreted and processed accordingly.

It is noted that the search box 230 provided in the digital map may allow the user to search for different items or stores in the targeted or untargeted geographic region or the same items or stores in a different geographic region as needed.

In one example, the digital map 250 can be dragged and zoomed to show detailed information. For example, the user can move the digital map 250 by clicking, tapping, swiping and dragging the map 250 by a touch input. For example, when a user would like to navigate the detailed map information regarding the target region 206 that within a certain radius to the marker 204 from where the user is located, different finger gestures may be utilized to interact with the digital map 250 to navigate over the digital map 250. In one example, different finger gestures may be utilized to pan, scale, and rotate the digital map 250 so as to locate a target destination or object in the digital map 250. For example, the digital map 250 may be panned in response to a touch and drag gesture input from a user's finger, a stylus or other input mechanism. In one example, a pinch gesture 208, as shown in FIG. 2, may be utilized to zoom in or out of the digital map 250 while a two-finger input followed by a rotation to zoom in or zoom out of the digital map 250.

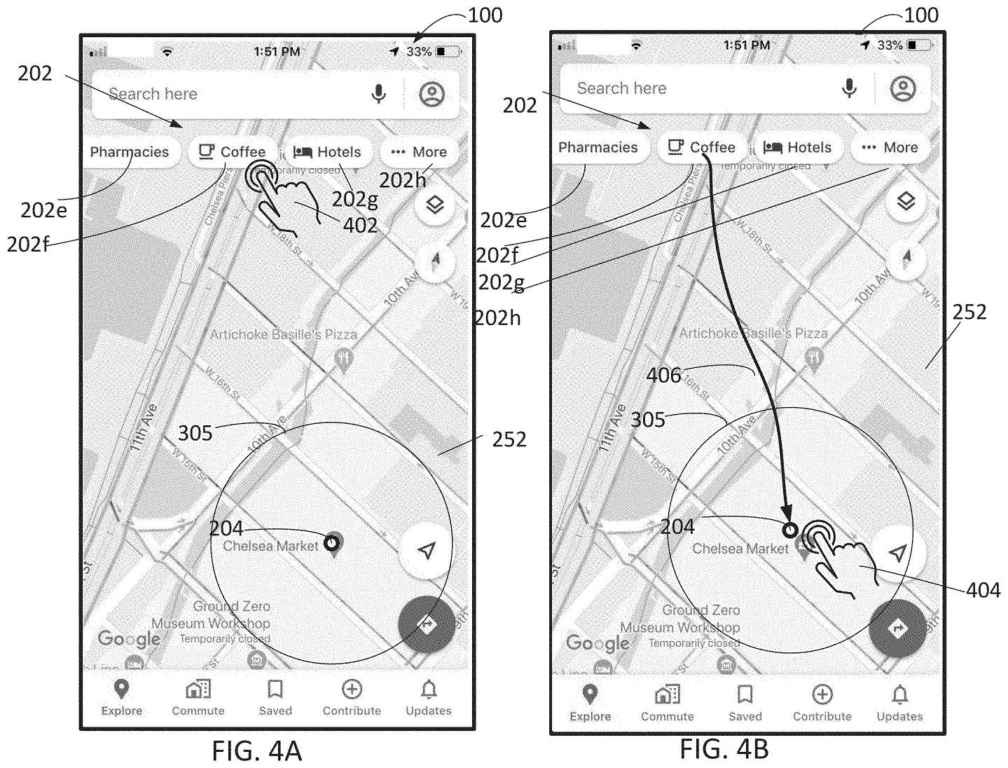

FIG. 3 depicts a zoom-in view of the digital map 252 of FIG. 2 after a touch input, such as a pinch gesture, is operated. After the pinch gesture input by the touch operation, the objects around the marker 204 may be zoomed in and magnified to form a focal region 350, or called a region of interest, shown on the display screen using the marker 204 as a focal point. It is noted that the size, area and range of the focal region 305 may be as large as the dimension of the full display screen of the computing device 100 as needed. Zoom functionality allows a user to quickly navigate to a region of interest within a continuous view of a larger presentation and then zoom in to that region of interest for detailed viewing, searching or editing. Alternatively, additional touch operations, such as different finger gestures, may be utilized to select and change the point of interest, such as setting a different marker and its adjacent regions on the digital map as a target area of further geographic search or query as needed. In one example, a tapping feature 302 may be utilized to mark a target object/feature as a marker on the digital map as needed.

FIG. 4A-4B depicts a drag-and-drop operation performed in the digital map 252 generated in the computing device 100. When the user intends to perform a search for coffee shops in the focal region 305, the user may perform a drag-and-drop operation by dragging the preformulated query, such as the coffee textual bubble 202f, by a finger pressing 402 toward the focal region 305, as shown in FIG. 4A. When the coffee textual bubble 202f is dragged and reached to the focal region 305, as shown by the arrow 406 in FIG. 4B, or to the marker 204 or the nearby entities close to the marker 204, the coffee textual bubble 202f may then be dropped. The coffee textual bubble 202f dropped in the focal region 305 creates a drop content that initiates a search command to the controller of the computing device 100 so as to perform the requested search in the digital map. The user therefore defines a search region by setting the size of the focal region 305, and defines the search command by the selection of a specific textual bubble 202f. This two-step search process provides a simple operation to define a two-part search criterion based on type of business and geographical area in this example. This simple human-machine interaction provides for a very effective and efficient search mechanism. The process provides technical advantages of a simplified human-machine interaction, reduced processing, improved speed, and easier physiological interaction with the device for the user.

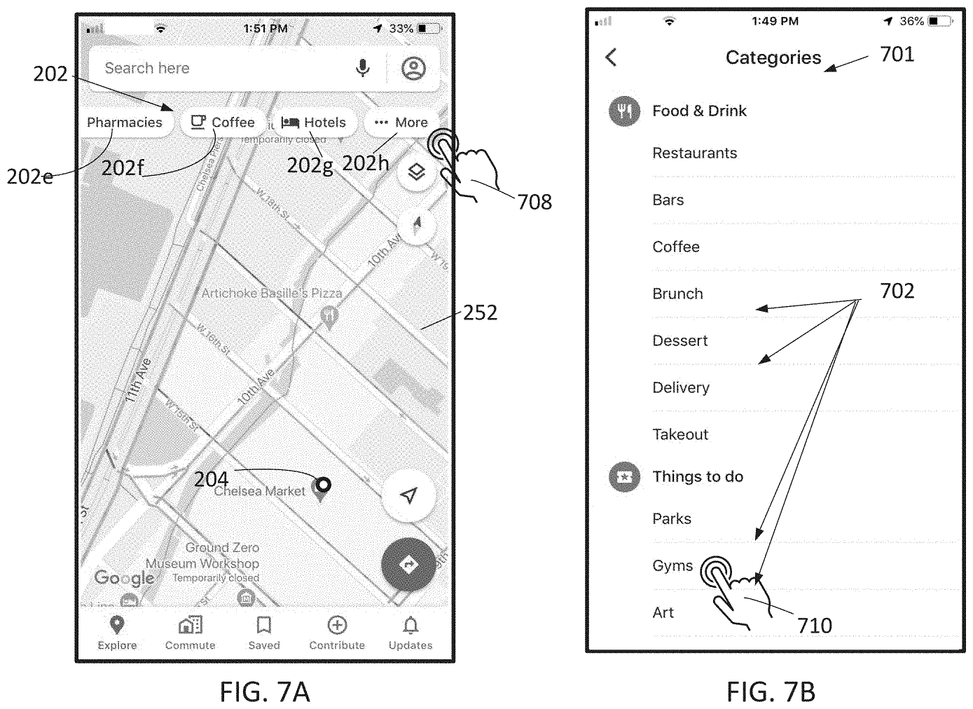

FIG. 5 depicts a query result after the coffee textual bubble 202f is dropped in the focal region 305, such as a target region or a region of interest. Once the drop command is received, the query results, such as the coffee shops represented by coffee icons 504 located or close to the marker 204, may then be populated and depicted in the digital map 252. By utilizing the drag-and-drop operation, which is a functionality provided by the drag-and-drop module 124 in the controller 116 of the computing device 100, a user may simply utilize a touch operation, such as the drag-and-drop operation, on the touch screen to perform the search intent without additional textual input, audio input, or other different input mechanism that requires relatively complicated input procedures. Thus, a time efficient and relatively accurate search may be obtained.

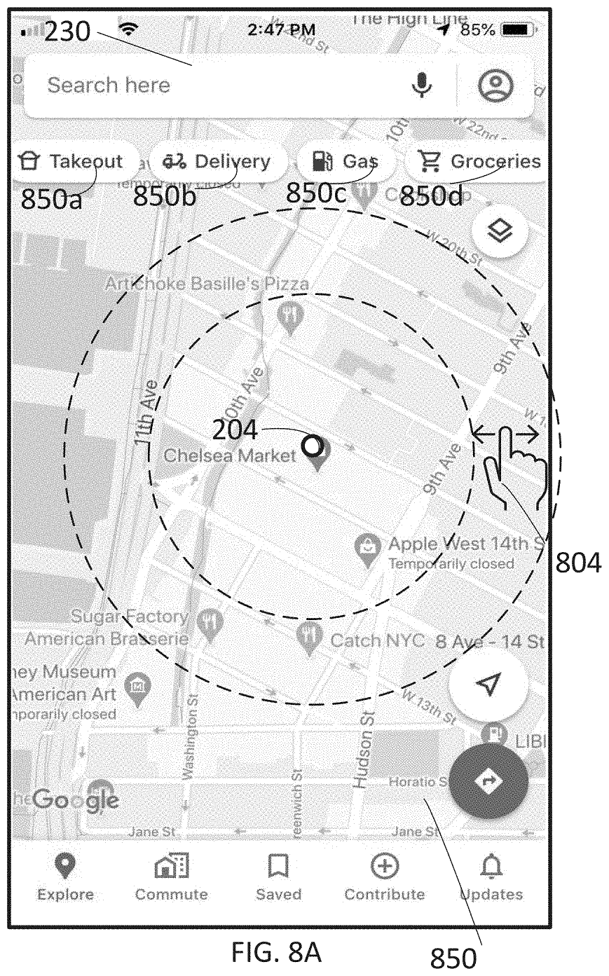

In one example, once the search results are populated in the digital map 252, another set of the textual bubbles may be generated to provide further details regarding the entities being searched. For example, as depicted in FIG. 5, once the coffee icons 504 are depicted, additional textual bubbles, such as open now 502a, top rated 502b, beer 502c, more filters 502d, may be populated to help the user to further narrow down his/her search preference or provide other indications, such as business hours or user rating, regarding to the coffee icons 504 to the user. The textual bubble of the filters 502d may be further tapped or pressed, as shown by a touch operation 508, to populate further searching criteria associated with search results as shown in FIG. 6. These sub-queries may be optional search/filtering commends that may or may not be performed based on user's habit, preference or past experiences. In the example depicted in FIG. 6, the sub-queries provide additional filtering procedures/commands to the search results to help further narrow down and/or reduce the numbers of the search results depicted in the digital map 252. Accordingly, the filtering procedures may provide a ranking list of the search results so as to help the user to find an entity that mostly fits his/her personal preference or individual need. It is noted that the filtering elements, such as hours, beer, takeout, wheelchair accessible entrance, tourists, breakfast, vegetarian options, are shown as examples in FIG. 6 for explanation purpose only. Such filtering elements may be personalized or custom input by the user who often utilizes and interacts with the computing device 100 as needed.

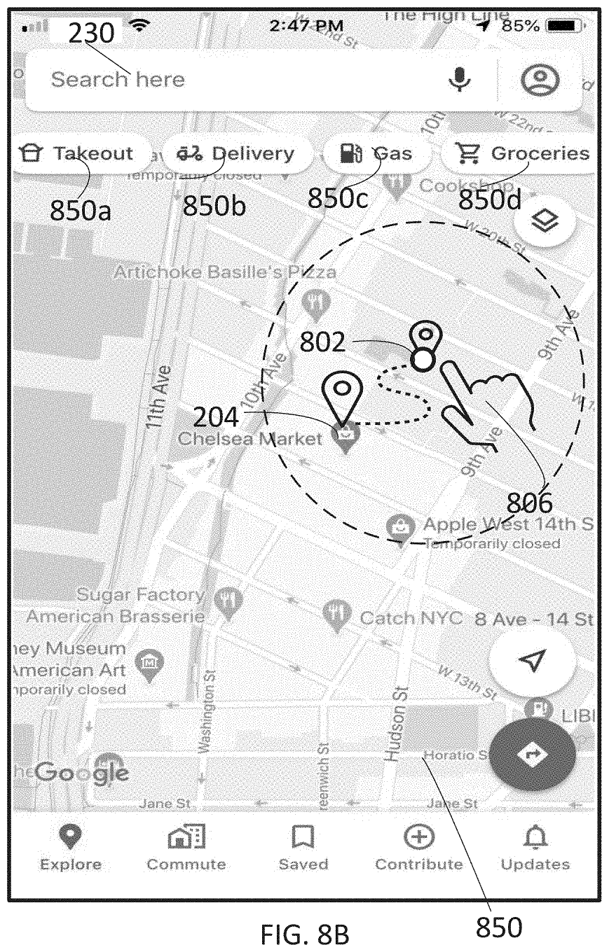

FIG. 7A depicts an example of one of the textual bubbles 202 that may be further selected to provide further categories 701 for suggested queries 702, such as different activities, features, businesses or other local resources as needed. In the example depicted in FIG. 7A, the textual bubble 202h, e.g., a query reciting a label of “ . . . More”, may be further tapped by a touch operation 708. FIG. 7B depicts the further break down list/categories 701 of the suggested queries 702 after the textual bubble 202h is tapped and selected. Once one of the suggested queries 702, such as “gyms”, is selected and tapped by a touch operation 710, a new textual bubble including the label of “gyms” will be generated to be placed in the digital map 252. The new generated textual bubble may be placed at any suitable location in the digital map 252, such as next to or below the textual bubble 202g with the “Hotel” label or replacing the textual bubble 202h to alter its label from “ . . . More” to “Gyms.” In such example, the textual bubble 202h may be selectable and switchable to repetitively retrieve the further categories/list 701 for suggested queries 702, as shown in FIG. 7B, to satisfy different search intents from the user as needed. It is noted that the suggested queries 702 on the list 701 may be edited by the user to customize and create a personal preferred activity/query list as needed. In some examples, each textual bubble 202 shown in the digital map 252 may also be editable or changeable to customize the suggested queries so that the user can visually locate the search query quickly and easily on the display screen of the computing device 100 so that a drag-and-drop operation may be quickly performed or an application to the textual bubble may be quickly performed to provide the desired search result to the user efficiently. Thus, the editable textual bubble 202 as well as the editable categories/list 701 provide the users with customized information and/or local resources about their current location or their target location with a minimal amount of manual data entry. A simple multi-filtering capability is therefore provided. This further simplifies the processing required to perform complex search operations.

In some examples, one or more of the textual bubbles 202 may be tapped or otherwise selected to provide a list of place names that allows the users to understand the nearby environment and perform a quick and easy search as needed. For example, one or more of the textual bubbles 202 may serve as a spatial navigation system that provides a list of place names, such as the nearby stores, buildings, landmarks, attributes, or features, based on user's custom settings or by the local popularity provided by the map application so that a user can glance the nearly environment and available stores, buildings, landmarks, attributes, features or the like located nearby to perform a geographic search that best fits their search intent.

In some examples, after the drag-and-drop operation, the search results may appear as a list that itemizes the plurality of search results on the list, rather than icons shown in the digital map, such as the example depicted in FIG. 5 described above. In this regard, the display screen may be divided into one or more user interfaces or zones, either horizontally or vertically, that can accommodate showing both the digital map and the list of search results on the display screen simultaneously. In some examples, the digital map may be tentatively replaced with the list of search results on the display screen, similar to the example depicted in FIG. 6, until the user inputs another operation for further action.

In further examples, the query may be performed by dragging or applying an input to the preformulated text bubble to a variety of location options presented on a display in a non-map format. For example, a list of locations may be provided in relation to the text bubbles. The locations may include street names, neighborhoods, cities, or any other identifiers for particular locations. The user may select a text bubble corresponding to a particular preformulated query and drag the text bubble to one of the locations in the list. While the foregoing example describes a list as the possible non-map format, it should be understood that any of a variety of other interface formats is possible.

In some examples, the preformulated queries may be programmed and presented on the display screen at a different location from the location where the digital map is presented in the display screen. For example, the preformulated queries and the digital map may be located at different user interfaces or two different regions/zones in the display screen. In this regard, the drag-and-drop operation may be performed by dragging the preformulated queries from a first user interface to a second user interface where the target of interest in the digital map is depicted to complete the query.

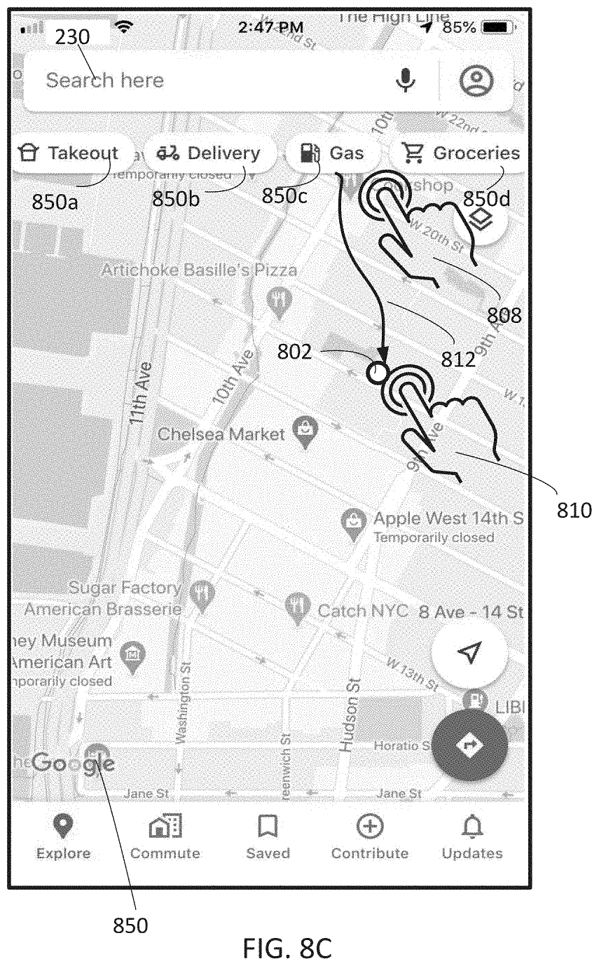

FIGS. 8A-8C depict different stages and examples of performing the drag-and-drop operations on the digital map 850. As described above, when a map application is launched in the computing device 100 by the user, the marker 204 may be automatically generated to indicate the geo-location of the user, e.g., the user carrying the computing device 100, in the digital map 850, as shown in FIG. 8A. The user may then perform different touch operations 804, such as pinching, sliding, swiping, long-press, or tapping, to determine which desired locations in close proximity to the marker 204 to be shown in the digital map 850. Once a target destination is located, a tap operation 806 may be performed to change the original marker 204 to a target marker 802, as shown in FIG. 8B. Although the example depicted in FIG. 8B shows that the target marker 802 is in close proximity to the original marker 204 where the user/computing device is located, it is noted that the target marker 802 may be selected to be at any location searched by touch operation or by providing a textual search or audio input in the search box 230 that best fits the user's search intent. Once the new target location is marked as the new marker 802, a drag-and-drop operation may be performed to drag a text bubble 850a, 850b, 850c, 850d, such as the text bubble 850c labeled as “Gas” depicted in FIG. 8C, by a dragging command initiated by the touch operation 808 by the user. The user may then drop the text bubble 850c to or in close proximity to the target marker 802 by a dropping command provided by a touch operation 810 to perform a gas station search around the locations where the target marker 802 is set in the digital map 850. After the dropped content, such as the text bubble 850c labeled as “Gas”, is received by the target marker 802 in the digital map 850, search results regarding the locations of the gas stations may be populated and shown in the digital map 850 in closer proximity to the target marker 802.

In some examples wherein the location of the marker 204, such as the location where the computing device is detected, and the location of destination, such as the target marker 802, are too far away to be both shown in the display screen simultaneously, more than one user interface may be utilized to depict two different locations at the different user interfaces as needed. Accordingly, the dragging and the dropping commands may be performed between the different user interfaces to perform the query.

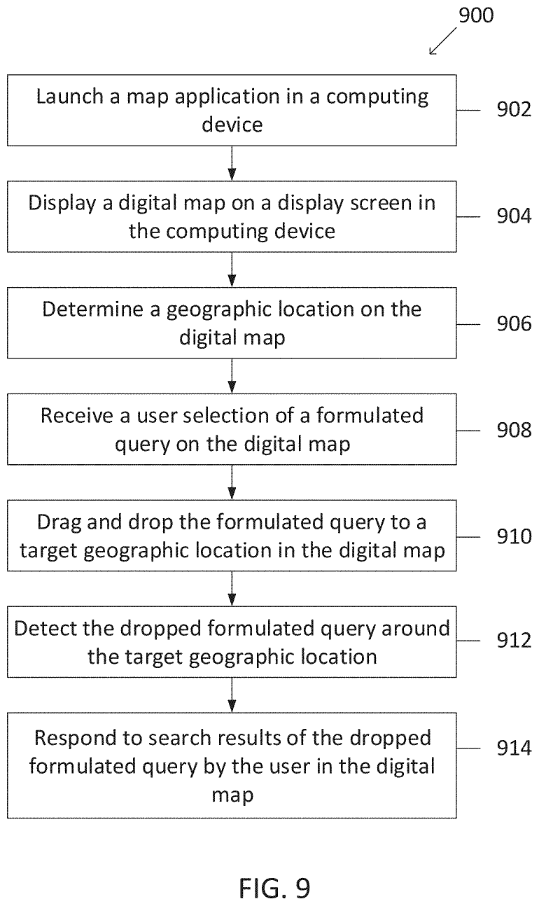

FIG. 9 illustrates an example method 900 for performing a drag-and-drop operation on a digital map generated from a map application in a computing device. Such methods may be performed by using the computing device 100 described above, modifications thereof, or any of a variety of other computing devices having different configurations. It should be understood that the operations involved in the following methods need not be performed in the precise order described. Rather, various operations may be handled in a different order or simultaneously, and operations may be added or omitted.

In block 902, a map application may be launched by a user actively interacting with a computing device, such as the computing device 100 depicted in FIG. 1.

In block 904, after the map application is launched, a digital map is then shown and depicted on a display screen of the computing device. In the meantime, the preformulated textual bubbles, providing different attribute queries, may also be shown in the digital map so as to help the user identify his/her search intent.

In block 906, as discussed above, once the map application is launched, the location identification system, such as the GSP circuitry, cellular location detector, or other appropriate systems, embedded in the computing device 100 may automatically provide a geographic location of the user on the digital map. In one example, such geographic location may be a region of interest where an attribute query is desired to be performed. In another example, the user may reset another geographic location in the digital map to be the region of interest where the attribute query is desired to be performed. In the situations wherein a user wants to search for certain attributes within a particular neighborhood, city, country, or other region, the user may further identify such region and set a new marker in such region prior to perform the attribute query in the digital map.

In block 908, the user may determine and select a preformulated query, such as a preformulated textual bubble, populated in the digital image to perform the attribute query. For example, when an user intends to investigate and look for a coffee shop in the region of interest, the user may first locate and identify the preformulated textual bubbles with a label of “Coffee”, such as textual bubble 220g in FIGS. 4A-4B. Other different preformulated textual bubbles are also available in the digital map that are ready to be selected and picked by the user based on the user's intended search need.

In block 910, after the intended search from the user is identified and the preformulated query, such as the textual bubble, associated with such intended search is located, a drag-and-drop operation may be performed. In other words, an input applied to the preformulated query may be detected by the computing device. The textual bubble as selected may be dragged to and toward the region of interest and then be dropped in the region of the interest defined in the digital map.

In block 912, once the selected textual bubble is dropped in the region or point of interest, the dropped command may trigger the operation of the computing device 100 to show, generate, populate, and depict the search results in the point or region of interest in the digital map. By utilizing the drag-and-drop operation, minimum textual or audio/sound input may be performed so that a great amount of textual or audio/sound input time may be saved and the likelihood of typographic typing error or sound recognition failure may be reduced and minimized.

In block 914, optionally, in the situations that the search results depicted in the digital map does not quite fit the user's intended search or the search results are in quite great numbers that require a further narrow-down to assist the user identify a search result that best fit the user's intent, additional filtering procedures or screening factors may be selected or utilized to help narrow down and reduce the numbers of the search result. Thus, by doing so, an efficient search result may be obtained as needed.

Thus, methods and apparatus that may perform a drag-and-drop operation for a geographical query in a digital map are provided. The drag-and-drop operation provided by the computing device allows the user to input a formulated query in a digital map with reduced or minimum textual input so as to provide a relatively accurate query that the computing device may easily capture and understand. Accordingly, a user can simply drag the formulated query that meets his or her search intent, which is already preset and appeared on the display, to a target geographic region of interest on the digital map. Thus, the intended query may be simply dragged and dropped to the target geographic region of interest in the digital map defined by the user with minimum textual input. As a result, the computing device may easily identify and understand the query command input from the user and respond the user with a geographical information that fits the user's intent of the query with minimum misunderstanding and/or input information from the user, thus saving input time, reducing likelihood of input error and enhancing search accuracy and efficiency.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of performing a query comprising:
providing, by one or more processors, a digital map for display on a computing device;
providing, by the one or more processors, a preformulated query for display in a user interface;
receiving an input applied to the preformulated query, wherein the input indicates an application of the preformulated query to a selected region of the digital map; and
performing, by the one or more processors, a geographic search based on the input applied to the preformulated query.

2. The method of claim 1, further comprising:
projecting, by the one or more processors, a plurality of search results to the selected region in the digital map.

3. The method of claim 2, further comprising:
filtering the search results based on a filtering command as received.

4. The method of claim 1, wherein providing, by the one or more processors, the preformulated query in the digital map further comprises:
detecting, by one or more processors, a geographic location of a user; and
marking, by one or more processors, the geographic location of the user in the digital map.

5. The method of claim 4, wherein the application of the preformulated query comprises a movement of the preformulated query.

6. The method of claim 1, wherein the preformulated query is represented as a textual bubble in the digital map.

7. The method of claim 6, wherein the textual bubble is editable.

8. The method of claim 4, wherein the preformulated query comprises a textual label related to attributes or local resources in close proximity to the geographic location.

9. The method of claim 1, wherein the preformulated query is presented at a preset location in the user interface irrelevant to a geographic location presented in the digital map.

10. The method of claim 1, wherein the input is a drag and drop command.

11. The method of claim 10, wherein the geographic search is completed by the drag and drop command applied in the digital map with minimum textual input.

12. A computing device, comprising:
one or more memories:
one or more processors in communication with the one or more memories, the one or more processors configured to:
provide a digital map for display on a computing device;
provide a preformulated query for display in a user interface;
receive an input applied to the preformulated query, wherein the input indicates an application of the preformulated query to a selected region of the digital map; and
perform a geographic search based on the input applied to the preformulated query at the selected region.

13. The computing device of claim 12, wherein the computing device is a GPS enabled portable device.

14. The computing device of claim 12, wherein the computing device is a database server in communication with one or more user devices.

15. The computing device of claim 12, wherein the input is a drag and drop command.

16. The computing device of claim 15, wherein the preformulated query is represented as a textual bubble in the digital map.

17. A computer-readable storage medium comprising executable computer instructions for performing operations comprising:
providing a preformulated query for display in a user interface;
receiving an input applied to the preformulated query, wherein the input indicates an application of the preformulated query to a selected region of the digital map; and
performing a geographic search based on the input applied to the preformulated query at the selected region.

18. The computer-readable storage medium of claim 17, wherein the input is a drag and drop command.

19. The computer-readable storage medium of claim 17, wherein the preformulated query is represented as a textual bubble in the digital map.

20. The computer-readable storage medium comprising executable computer instructions for performing operations of claim 17, further comprising:
detecting a geographic location of a user; and
marking the geographic location in the digital map prior to receiving the input applied to the preformulated query.
